(19) United States
(12) Patent Application Publication
(10) Pub. No.: US 2021/0031451 A1
(43) Pub. Date: Feb. 4, 2021

(54) TEMPERATURE REGULATED STEREOLITHOGRAPHY APPARATUS WITH INFRARED HEATING

(71) Applicant: Carbon, Inc., Redwood City, CA (US)

(72) Inventors: Anant Chimmalgi, Los Altos, CA (US); Jordan Christopher Fidler, Milbrae, CA (US); Ariel M. Hermann, San Francisco, CA (US)

(21) Appl. No.: 16/965,741

(22) PCT Filed: Apr. 16, 2020
(86) PCT No.: PCT/US2019/027606

§ 371 Date: Jul. 29, 2020

Related U.S. Application Data
(60) Provisional application No. 62/658,814, filed on Apr. 17, 2018.

(51) Int. Cl. B29C 64/295; B29C 64/124; B29C 64/393; B33Y 10/00; B33Y 30/00; B33Y 50/02

(52) U.S. Cl. CPC B29C 64/295; B29C 64/124; B33Y 50/02; B33Y 10/00; B33Y 30/00; B29C 64/393

(57) ABSTRACT

A stereolithography apparatus includes a light transmissive window defining a build region in which a polymerizable resin can be supported, the window characterized by a transmission spectra curve having a low transmissivity region between first and second high transmissivity regions; a carrier platform positioned above the window; a drive operatively associated with the carrier platform and the window and configured for advancing the window and the carrier platform away from one another; an ultraviolet light source positioned beneath the window; at least one infrared heat source positioned beneath the window; at least one temperature sensor operatively associated with the build region and configured to sense (directly or indirectly) the temperature of a polymerizable resin in the build region; and a temperature controller operatively associated with the temperature sensor and the infrared heat source, the controller configured to intermittently activate the infrared heat source to an elevated temperature at which the emission spectra peak for the heat source is within the first high transmissivity region.

### RELATED APPLICATIONS

This applications claims priority to U.S. Provisional Application Ser. No. 62/658,814, filed Apr. 17, 2018, the disclosure of which is hereby incorporated by reference in its entirety.

### FIELD OF THE INVENTION

The present invention concerns methods of additive manufacturing, and particularly concerns methods of additive manufacturing by stereolithography in which polymerizable resins are maintained at an elevated temperature to reduce viscosity thereof.

### BACKGROUND

A group of additive manufacturing techniques sometimes referred to as “stereolithography” create a three-dimensional object by the sequential polymerization of a light polymerizable resin. Such techniques may be “bottom-up” techniques, where light is projected into the resin onto the bottom of the growing object through a light transmissive window, or “top down” techniques, where light is projected onto the resin on top of the growing object, which is then immersed downward into the pool of resin.

The recent introduction of a more rapid stereolithography technique sometimes referred to as continuous liquid interface production (CLIP) has expanded the usefulness of stereolithography from prototyping to manufacturing. See J. Tumbleston, D. Shirvanyants, N. Ermoshkin et al., Continuous liquid interface production of 3D objects, SCIENCE 347, 1349-1352 (published online 16 Mar. 2015); U.S. Pat. Nos. 9,211,678; 9,205,601; and 9,216,546 to DeSimone et al.; see also R. Janusziewicz, et al., Layerless fabrication with continuous liquid interface production, PNAS 113, 11703-11708 (18 Oct. 2016).

Dual cure resins for additive manufacturing were introduced shortly after the introduction of CLIP, expanding the usefulness of stereolithography for manufacturing a broad variety of objects still further. See Rolland et al., U.S. Pat. Nos. 9,676,963, 9,453,142 and 9,598,606; J. Poelma and J. Rolland, Rethinking digital manufacturing with polymers, SCIENCE 358, 1384-1385 (15 Dec. 2017).

Stereolithography resins—both conventional and dual cure—are generally viscous, and that viscosity can limit the speeds of production otherwise attainable by CLIP. It has been recognized that resins may be heated to reduce their viscosity (see, e.g., U.S. Pat. Nos. 9,211,678; 9,205,601; and 9,216,546 to DeSimone et al.). Typical heating techniques, however, can heat components of the apparatus itself rather than simply the resin, resulting in slower thermal control response times, and potentially excessive heating of the resin itself (which can in dual cure resins then in turn trigger a second, heat, cure, thereby further increasing the viscosity of the resin). Hence, new approaches to thermal control of resins in stereolithography apparatus are needed.

### SUMMARY

In some embodiments, a stereolithography apparatus includes a light transmissive window defining a build region in which a polymerizable resin can be supported, the window characterized by a transmission spectra curve having a low transmissivity region between first and second high transmissivity regions; a carrier platform positioned above the window; a drive operatively associated with the carrier platform and the window and configured for advancing the window and the carrier platform away from one another; an ultraviolet light source positioned beneath the window; at least one infrared heat source positioned beneath the window; at least one temperature sensor operatively associated with the build region and configured to sense (directly or indirectly) the temperature of a polymerizable resin in the build region; and a temperature controller operatively associated with the temperature sensor and the infrared heat source, the controller configured to intermittently activate the infrared heat source to an elevated temperature at which the emission spectra peak for the heat source is within the first high transmissivity region.

In some embodiments, the controller comprises a proportional-integral-derivative (PID) controller, a proportional integral (PI) controller, or a dynamic matrix controller (DMC).

In some embodiments, the controller is configured to perform pulse-width modulation to each the infrared heat source.

In some embodiments, the apparatus includes a shutter positioned between the window and each the infrared heat source, and the shutter is operatively associated with the controller.

In some embodiments, the window comprises an inorganic lower support (e.g., glass, sapphire, etc.) and an organic polymer (e.g., a fluoropolymer) layer on the support

In some embodiments, the controller is configured to maintain the resin within a predetermined temperature range of from 30 or 35° C. to 60, 80, or 100° C., or more.

In some embodiments, the temperature sensor comprises a contact or non-contact temperature sensor operatively associated with the window.

In some embodiments, the infrared heat source incudes a conduction element comprising a metal, metal oxide, carbon compound, intermetallic compound, or ceramic.

In some embodiments, the at least one infrared heat source comprises a plurality of heat sources, each of the plurality focused on separate regions of the window, and each of the infrared heat sources is independently controlled by the temperature controller.

In some embodiments, a method of maintaining the actual temperature of a polymerizable resin in a stereolithography apparatus above a predetermined minimum temperature is provided, and the predetermined minimum temperature is greater than room temperature. The method includes providing a stereolithography apparatus comprising (i) a light transmissive window defining a build region on which an ultraviolet light polymerizable resin is supported, (ii) at least one infrared heat source positioned beneath the window, and (iii) a carrier platform positioned above the window and operatively associated therewith, the window characterized by a transmission spectra curve having a low transmissivity region between a first high transmissivity region and a second high transmissivity region; advancing the carrier platform and the window towards one another until the carrier platform contacts the polymerizable resin and reduces the actual temperature of the resin to less than the predetermined temperature; sensing (directly or indirectly) a decrease in actual temperature of the polymerizable resin to less than the predetermined minimum temperature; and intermittently activating the infrared heat source to an elevated temperature at which the emission spectra peak for the heat source is within the first high transmissivity region, the intermittent activation carried out for a time sufficient to return the polymerizable resin to an actual temperature at or above the predetermined minimum temperature.

In some embodiments, the polymerizable resin is viscous at room temperature.

In some embodiments, the polymerizable resin comprises a free-radical polymerizable resin.

In some embodiments, the resin comprises a dual cure resin.

In some embodiments, the predetermined minimum temperature is at least 30 or 35° C.

In some embodiments, the method includes a step of warming the resin to an actual temperature greater than the predetermined minimum temperature prior to the advancing step.

In some embodiments, the intermittently activating step is discontinued prior to the resin actual temperature exceeding a predetermined maximum temperature (e.g., up to 60, 80, or 100° C., or more).

In some embodiments, first high transmissivity region is of wavelengths shorter than those of the low transmissivity region.

In some embodiments, the first high transmissivity region is of wavelengths longer than those of the low transmissivity region.

In some embodiments, the at least one infrared heat source comprises a plurality of heat sources, each of the plurality focused on separate regions of the window, and each of the infrared heat sources is independently controlled by the temperature controller.

In some embodiments, the method includes a step of stereolithographically producing an object in the apparatus from the polymerizable resin by exposing the resin to spatially and temporally patterned ultraviolet light.

In some embodiments, the method includes continuing the sensing and intermittently activating steps during the stereolithographically producing step.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 schematically illustrates one embodiment an apparatus and method of the present invention.

FIG. 2 schematically illustrates window transmissivity, and infrared source emission spectral energy density at high and low operating temperatures, for an illustrative embodiment of the present invention.

### DETAILED DESCRIPTION

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus the exemplary term “under” can encompass both an orientation of over and under. The device may otherwise be oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer or section discussed herein could be termed a second element, component, region, layer or section without departing from the teachings of the present invention. The sequence of operations (or steps) is not limited to the order presented in the claims or figures unless specifically indicated otherwise.

### 1. Stereolithography Apparatus and Resins

Resins for additive manufacturing are known and described in, for example, DeSimone et al., U.S. Pat. Nos. 9,211,678; 9,205,601; and 9,216,546. Dual cure resins for additive manufacturing are known and described in, for example, Rolland et al., U.S. Pat. Nos. 9,676,963; 9,598,606; and 9,453,142. Non-limiting examples of dual cure resins include, but are not limited to, resins for producing objects comprised of polymers such as polyurethane, polyurea, and copolymers thereof; objects comprised of epoxy; objects comprised of cyanate ester; objects comprised of silicone, etc.

Techniques for additive manufacturing are known. Suitable techniques include bottom-up or top-down additive manufacturing, generally known as stereolithography. Such methods are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al. The disclosures of these patents and applications are incorporated by reference herein in their entirety.

In some embodiments, the object is formed by continuous liquid interface production (CLIP). CLIP is known and described in, for example, PCT Application Nos. PCT/US2014/015486 (U.S. Pat. No. 9,211,678); PCT/US2014/015506 (U.S. Pat. No. 9,205,601), PCT/US2014/015497 (U.S. Pat. No 9,216,546), and in J. Tumbleston, D. Shirvanyants, N. Ermoshkin et al., Continuous liquid interface production of 3D Objects, Science 347, 1349-1352 (2015). See also R. Janusziewcz et al., Layerless fabrication with continuous liquid interface production, Proc. Natl. Acad. Sci. USA 113, 11703-11708 (Oct. 18, 2016). In some embodiments, CLIP employs features of a bottom-up three-dimensional fabrication as described above, but the irradiating and/or the advancing steps are carried out while also concurrently maintaining a stable or persistent liquid interface between the growing object and the build surface or window, such as by: (i) continuously maintaining a dead zone of polymerizable liquid in contact with the build surface, and (ii) continuously maintaining a gradient of polymerization zone (such as an active surface) between the dead zone and the solid polymer and in contact with each thereof, the gradient of polymerization zone comprising the first component in partially-cured form. In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone. Other approaches for carrying out CLIP that can be used in the present invention and obviate the need for a semipermeable “window” or window structure include utilizing a liquid interface comprising an immiscible liquid (see L. Robeson et al., WO 2015/164234, published Oct. 29, 2015), generating oxygen as an inhibitor by electrolysis (see I Craven et al., WO 2016/133759, published Aug. 25, 2016), and incorporating magnetically positionable particles to which the photoactivator is coupled into the polymerizable liquid (see J. Rolland, WO 2016/145182, published Sep. 15, 2016).

Other examples of methods and apparatus for carrying out particular embodiments of CLIP include, but are not limited to: Batchelder et al., Continuous liquid interface production system with viscosity pump, US Patent Application Pub. No. US 2017/0129169 (May 11, 2017); Sun and Lichkus, Three-dimensional fabricating system for rapidly producing objects, US Patent Application Pub. No. US 2016/0288376 (Oct. 6, 2016); Willis et al., 3d print adhesion reduction during cure process, US Patent Application Pub. No. US 2015/0360419 (Dec. 17, 2015); Lin et al., Intelligent 3d printing through optimization of 3d print parameters, US Patent Application Pub. No. US 2015/0331402 (Nov. 19, 2015); and D. Castanon, Stereolithography System, US Patent Application Pub. No. US 2017/0129167 (May 11, 2017).

After the object is formed, it is typically cleaned, and then further cured, preferably by baking (although further curing may in some embodiments be concurrent with the first cure, or may be by different mechanisms such as contacting to water, as described in U.S. Pat. No. 9,453,142 to Rolland et al.).

### 2. Methods and Apparatus Employing Infrared Heating

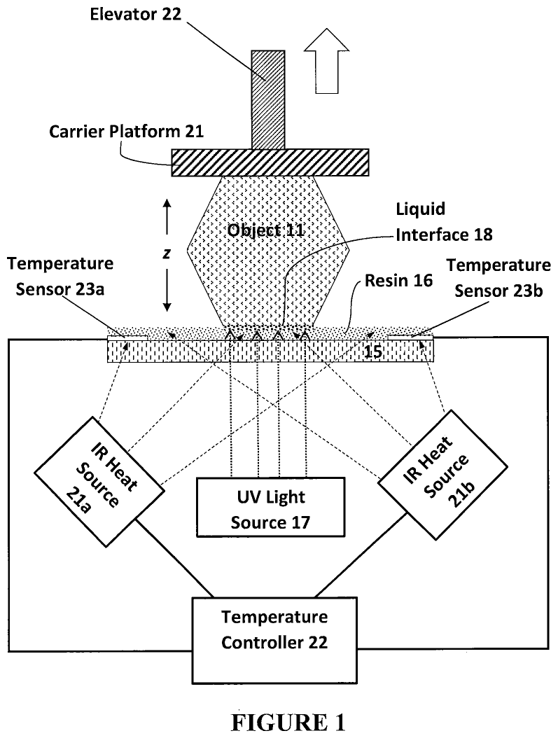

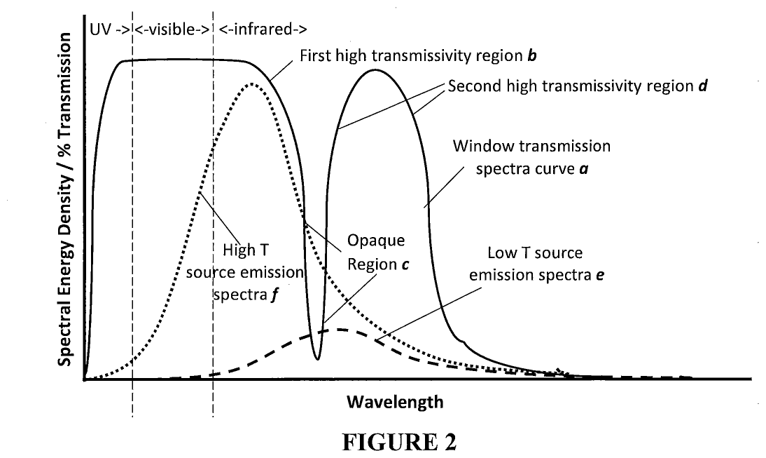

As noted above, the present invention provides a stereolithography apparatus as illustrated in the non-limiting Examples of FIGS. 1-2. The apparatus generally includes a light transmissive window 15 defining a build region in which a polymerizable resin 16 can be supported, the window characterized by a transmission spectra curve (a, FIG. 2) having a low transmissivity or relatively “opaque” region c between a first high transmissivity region b and a second high transmissivity region d. The window may be comprised of a single layer of material, or multiple layers. In preferred embodiments, at least the top layer of window, contacting the polymerisable resin 16, is permeable to an inhibitor of polymerization, such as oxygen. In some embodiments, the window comprises an inorganic lower support (e.g., glass, sapphire, etc.) and an organic polymer (e.g., a fluoropolymer) layer on the support. In some embodiments, additional layers including adhesives, channels for oxygen supply, etc., may be included as desired. In some embodiments, the window may have an omniphobic surface coating thereon, for contacting the polymerizable resin (see, e.g., M. Boban et al., ACS Appl. Mater. Intefaces 10, 11406-11413 (2018); A. Tuteja et al., PNAS 105, 18200-18205 (2008); G. Allen, US Patent Application Pub. No. US20180057692; R. Langer et al., US Patent Application Pub. No. US20170266931; and T. Aytug, US Patent Application Pub. No. US 20150239772).

A carrier platform 21 is positioned above the window and an elevator assembly 22 is operatively associated with the carrier platform to serve as a drive for advancing the platform up and away from the window in the z direction (in an alternative embodiment, the drive assembly can be configured to lower the window down and away from the carrier platform.

One or more ultraviolet (UV) light source(s) 17 is positioned beneath the window, and a pair of infrared heat sources 21a, 21b are positioned beneath the window (though a single source, or more than two, can be employed). Any suitable source of spatially and temporally patterned UV light can be used as the UV light source 17, including combinations of laser or diode light sources combined with micromirror arrays, LCD arrays, etc. Any suitable infrared heat source can be used, including but not limited to those where the infrared heater incudes a conduction element comprising a metal, metal oxide, carbon compound, intermetallic compound, or ceramic. (See, e.g., U.S. Pat. No. 9,061,934).

One or more temperature sensors (in the illustrated embodiment, a pair 23a, 23b) are operatively associated with the build region, and are configured to sense, directly or indirectly, the temperature of a polymerizable resin 16 in the build region. Any suitable temperature sensor(s) can be used, including contact or non-contact temperature sensors such as infrared sensors, pyrometers, microbolometers, thermal cameras, thermistors, etc.). The currently preferred sensor is an IR sensor positioned beneath the window 15, and close to the plane of the UV light source 17, directed to the center bottom of the window. Such an IR sensor (or sensors, if a plurality are employed) can be tuned to a wavelength such that it primarily senses the temperature of the window itself as a surrogate for the temperature of the resin 16 (with the controller 22 adjusted or configured accordingly), or one which is tuned to a wavelength that looks through the window and more directly sense the temperature of the resin 16.

At least one temperature controller 22 is operatively associated with the temperature sensor and the infrared heat source, the controller configured to intermittently activate the infrared heat source to an elevated temperature at which the emission spectra peak for the heat source is within the first high transmissivity region as represented by High T source emission spectra f in FIG. 2, rather than Low T source emission spectra e in FIG. 2. Suitable controllers include proportional-integral-derivative (PID) controllers, proportional integral (PI) controllers, dynamic matrix controllers (DMCs), etc. (See, e.g., U.S. Pat. Nos. 9,841,186 9,795,528; 9,766,287; 9,220,362). The controllers may perform pulse-width modulation to each the infrared heat source. The controllers may be configured to maintain the resin within a predetermined temperature range of from 30 or 35° C. to 60, 80, or 100° C., or more. In addition, where a plurality of heat sources are used, each focused on separate (optionally partially overlapping) regions of the window, the heat sources may be independently controlled by the temperature controller(s), such as where different regions of the window are subject to different heat input (e.g., from heat of polymerization) or heat drain (e.g., from contact with an adjacent supporting structure, contact to a carrier plate, etcl). For such separate control of the heat sources, multiple, separately focused or directed, temperature sensor may be used, or one or more infrared camera (providing a thermal map) can be used to provide independent data for independent control of the the multiple heat sources.

While not essential, in some embodiments a shutter (not illustrated) may be included between each heat source and the window, which shutter is under the control of the controller, and which shutter is closed as the heat source warms or cools and its emission peak passes through the opaque region c of the window, but open while the heat source is operated at a temperature wherein its emission spectra peak is in the first region.

FIG. 2 illustrates the currently preferred embodiment where the heat source is operated at a high temperature where its emission peak is in the shorter wavelength high transmissivity region (f in FIG. 2), as opposed to the longer wavelength high transmissivity region, d in FIG. 2). In an alternative embodiment, the labels of the first and second high transmissivity regions can be reversed, and the heat source operated at a temperature sufficiently low so that its peak resides in the longer wavelength high transmissivity region. Because of the flatter peak of the emission spectra of the heat source operated under these conditions (and greater corresponding non-specific warming of window and other apparatus components) this embodiment is currently less preferred.

As also noted above, an aspect of the invention is a method of maintaining the actual temperature of a polymerizable resin in a stereolithography apparatus above a predetermined minimum temperature, which predetermined minimum temperature is greater than room temperature. The method includes: providing a stereolithography apparatus comprising (i) a light transmissive window defining a build region on which an ultraviolet light polymerizable resin is supported, (ii) at least one infrared heat source positioned beneath the window, and (iii) a carrier platform positioned above the window and operatively associated therewith, the window characterized by a transmission spectra curve having a low transmissivity region between a first high transmissivity region and a second high transmissivity region; advancing the carrier platform and the window towards one another until the carrier platform contacts the polymerizable resin and reduces the actual temperature of the resin to less than the predetermined temperature; sensing (directly or indirectly) a decrease in actual temperature of the polymerizable resin to less than the predetermined minimum temperature; and intermittently activating the infrared heat source to an elevated temperature at which the emission spectra peak for the heat source is within the first high transmissivity region, the intermittent activation carried out for a time sufficient to return the polymerizable resin to an actual temperature at or above the predetermined minimum temperature.

In general, the resin is one which is viscous at room or ambient temperature, and comprises a free-radical polymerizable resin (and preferably includes a photoinitiator having a peak light absorption in the ultraviolet range). In some embodiments, the resin comprises a dual cure resin.

The predetermined minimum temperature may, for example, be at least 30 or 35° C. In some embodiments, the method may further comprise the step of warming the resin to an actual temperature greater than the predetermined minimum temperature prior to the advancing step. And in some embodiments, the intermittently activating step can be discontinued prior to the resin actual temperature exceeding a predetermined maximum temperature (e.g., of up to 60, 80, or 100° C., or more).

As noted above, in some embodiments the first high transmissivity region is of wavelengths shorter than those of the low transmissivity region (e.g., and includes at least a portion of the ultraviolet light range at which a photoinitiator in the polymerizable resin has an absorption peak); while in other embodiments the first high transmissivity region is of wavelengths longer than those of the low transmissivity region. As also noted above, in some embodiments, where the at least one infrared heat source comprises a plurality of heat sources, each of the plurality focused on separate (optionally partially overlapping) regions of the window, and wherein each of the infrared heat sources is independently controlled by the temperature controller.

Following initial sequences as described above, the method may further include the step of stereolithographically producing an object in the apparatus from the polymerizable resin by exposing the resin to spatially and temporally patterned ultraviolet light, while advancing the carrier and window away from one another, until that object is produced. The sensing and intermittently activating steps may be continued during the stereolithographically producing step.

1. A stereolithography apparatus, comprising:
a light transmissive window defining a build region in which a polymerizable resin can be supported, said window characterized by a transmission spectra curve having a low transmissivity region between first and second high transmissivity regions;
a carrier platform positioned above said window;
a drive operatively associated with said carrier platform and said window and configured for advancing said window and said carrier platform away from one another;
an ultraviolet light source positioned beneath said window;
at least one infrared heat source positioned beneath said window;
at least one temperature sensor operatively associated with said build region and configured to sense the temperature of a polymerizable resin in said build region; and
a temperature controller operatively associated with said temperature sensor and said infrared heat source, said controller configured to intermittently activate said infrared heat source to an elevated temperature at which the emission spectra peak for said heat source is within said first high transmissivity region.

2. The apparatus of claim 1, wherein said controller comprises a proportional-integral-derivative (PID) controller, a proportional integral (PI) controller, or a dynamic matrix controller (DMC).

3. The apparatus of claim 1, wherein said controller is configured to perform pulse-width modulation to each said infrared heat source.

4. The apparatus of claim 1, further comprising a shutter positioned between said window and each said infrared heat source, said shutter operatively associated with said controller.

5. The apparatus of claim 1, wherein said window comprises an inorganic lower support and an organic polymer layer on said support.

6. The apparatus of claim 1, said controller configured to maintain the resin within a predetermined temperature range of from 30° C. or more.

7. The apparatus of claim 1, wherein said temperature sensor comprises a contact or non-contact temperature sensor operatively associated with said window.

8. The apparatus of claim 1, wherein said infrared heat source incudes a conduction element comprising a metal, metal oxide, carbon compound, intermetallic compound, or ceramic.

9. The apparatus of claim 1, wherein said at least one infrared heat source comprises a plurality of heat sources, each of said plurality focused on separate regions of said window, and wherein each of said infrared heat sources is independently controlled by said temperature controller.

10. A method of maintaining the actual temperature of a polymerizable resin in a stereolithography apparatus above a predetermined minimum temperature, which predetermined minimum temperature is greater than room temperature, comprising:
providing a stereolithography apparatus comprising (i) a light transmissive window defining a build region on which an ultraviolet light polymerizable resin is supported, (ii) at least one infrared heat source positioned beneath said window, and (iii) a carrier platform positioned above said window and operatively associated therewith, the window characterized by a transmission spectra curve having a low transmissivity region between a first high transmissivity region and a second high transmissivity region;
advancing said carrier platform and said window towards one another until said carrier platform contacts said polymerizable resin and reduces the actual temperature of said resin to less than said predetermined temperature;
sensing a decrease in actual temperature of said polymerizable resin to less than said predetermined minimum temperature; and
intermittently activating said infrared heat source to an elevated temperature at which the emission spectra peak for said heat source is within said first high transmissivity region, said intermittent activation carried out for a time sufficient to return said polymerizable resin to an actual temperature at or above said predetermined minimum temperature.

11. The method of claim 10, wherein said polymerizable resin is viscous at room temperature.

12. The method of claim 10, wherein said polymerizable resin comprises a free-radical polymerizable resin.

13. The method of claim 10, wherein said resin comprises a dual cure resin.

14. The method of claim 10, wherein said predetermined minimum temperature is at least 30 or 35° C.

15. The method of claim 10, further comprising the step of warming said resin to an actual temperature greater than said predetermined minimum temperature prior to said advancing step.

16. The method of claim 10, wherein said intermittently activating step is discontinued prior to said resin actual temperature exceeding a predetermined maximum temperature.

17. The method of claims 10, wherein said first high transmissivity region is of wavelengths shorter than those of said low transmissivity region.

18. The method of claim 10, wherein said first high transmissivity region is of wavelengths longer than those of said low transmissivity region.

19. The method of claim 10, wherein said at least one infrared heat source comprises a plurality of heat sources, each of said plurality focused on separate regions of said window, and wherein each of said infrared heat sources is independently controlled by said temperature controller.

20. The method of claim 10, further comprising the step of stereolithographically producing an object in said apparatus from said polymerizable resin by exposing said resin to spatially and temporally patterned ultraviolet light.

21. The method of claim 20, further comprising continuing said sensing and intermittently activating steps during said stereolithographically producing step.
